(19) United States
(12) Patent Application Publication
(10) Pub. No.: US 2021/0253879 A1
(43) Pub. Date: Aug. 19, 2021

(54) Security Documents and Security Devices Comprising Infrared-Absorbent Compositions

(71) Applicant: CCL Secure Pty Ltd, Craigieburn (AU)

(72) Inventors: Michael Hardwick, Craigieburn (AU); Gary Fairless Power, Craigieburn (AU); Ben Stevens, Craigieburn (AU)

(21) Appl. No.: 17/211,375

(22) Filed: Mar. 24, 2021

Related U.S. Application Data
(63) Continuation-in-part of application No. PCT/AU2019/051033, filed on Sep. 25, 2019.

(30) Foreign Application Priority Data
Sep. 25, 2018 (AU) 2018903610

(51) Int. Cl. C09D 5/32; C08J 7/04; C09D 7/61; B42D 25/351; B42D 25/382; B42D 25/29; G07D 7/12

(52) U.S. Cl. CPC C09D 5/32; C08J 7/0427; C09D 7/61; B42D 25/351; C08K 2003/2241; B42D 25/29; G07D 7/12; C08J 2323/12; B42D 25/382

(57) ABSTRACT

The invention provides a security document having a transparent window, the security document comprising: a transparent polymeric substrate; an infrared-absorbent composition coated on or incorporated within the substrate at the window, the infrared-absorbent composition comprising particles of doped or Magnéli phase tungsten oxide.

### CROSS-REFERENCE TO RELATED APPLICATIONS

This application is a bypass-continuation of PCT International Patent Application No. PCT/AU2019/051033, filed on Sep. 25, 2019, which claims priority to Australian Patent Application No. 2018903610, filed on Sep. 25, 2018, which are incorporated by reference herein in their entirety.

### TECHNICAL FIELD

The present invention relates to security documents, security devices on security documents, and methods of producing such security devices. In particular, the security documents and security devices include an infrared-absorbent composition comprising particles of doped or Magnéli phase tungsten oxide. The invention also relates to methods of detecting or inspecting security documents which include the infrared-absorbent composition.

### BACKGROUND OF INVENTION

It is important that security documents such as bank notes, credit cards, ID documents (including passports), land title, share and educational certificates, packaging materials for high-value goods, security labels and security cards should be difficult to replicate by counterfeiters and be provided with features allowing their authentication.

A number of different strategies have been disclosed for securing and authenticating such security documents. The use of polymeric films as substrates offers an inherent advantage, due to the greater difficulty in copying and printing on such temperature-sensitive materials and due to the amenability to incorporating a variety of visible and hidden security features, including prominent transparent windows, optically active features and shadow images.

Infrared absorbent materials have also been used to enhance the security of bank notes for a long time. When irradiated with infrared radiation, portions of the bank note covered with such compositions appear dark under an infrared camera. Thus, for example, the compositions may form part of a feature, such as an overt printed design element which is visible in natural light, but which may also be detected as a covert feature under infrared radiation. Infrared-absorbent properties of security documents may also be exploited to facilitate machine-detection and inspection of documents such as bank notes.

Traditionally, infrared-absorbent compositions for security features comprise carbon black, which has the disadvantage of having a black colour. In practice, carbon black is thus most suited to black intaglio printed features, although carbon black may also be mixed with other colours to produce a feature with a “dirty” appearance. Other infrared absorbing materials, including metal oxides such as doped tin oxides (e.g. indium tin oxide) and dyes such as chlorinated organic compounds (such as the Epolight range from Epolin Inc) also have undesirably strong absorption in the visible light spectrum. This typically produces marked colouration (e.g. green for Epolight range) when the material is used at a loading sufficient for an effective infrared-absorbent security feature. Moreover, some infrared-absorbent materials may have poor chemical resistance or adhesion.

As such, the use of infrared-absorbent compositions on security documents has previously been limited to those security features adapted to tolerate these disadvantages. In other cases, infrared-absorbent security features have been provided, but the characteristic infrared absorption is less than desired due to the need to maintain low loadings of coloured absorbent materials. There is therefore an ongoing need for new security documents, security features on such documents, and methods for detecting or inspecting such documents, which at least partially address one or more of the above-mentioned short-comings or provide a useful alternative.

A reference herein to a patent document or other matter which is given as prior art is not to be taken as an admission that the document or matter was known or that the information it contains was part of the common general knowledge as at the priority date of any of the claims.

### SUMMARY OF INVENTION

In accordance with a first aspect the invention provides a security document having a transparent window, the security document comprising: a polymeric substrate; and an infrared-absorbent composition coated on or incorporated within the substrate at the window, the infrared-absorbent composition comprising particles of doped or Magnéli phase tungsten oxide.

As a result of the infrared-absorbent composition, the window of the security document, or a security device thereon, may in certain embodiments be detected or inspected by an infrared scanning device of a machine for processing or inspecting the security document.

In accordance with a second aspect the invention provides a method of detecting or inspecting a security document according to the first aspect, the method comprising: irradiating the window with light comprising at least infrared radiation; and detecting the infrared radiation transmitted through or reflected by the window and/or a security device thereon.

The infrared-absorbent composition according to the invention is surprisingly found to provide a strong absorption of near-infrared absorption radiation, believed by the inventors to be sufficient to allow detection of bank notes, having windows coated by or incorporating the composition, using certain infrared scanners, including some conventional sensors designed for detecting paper bank notes. Such windows retain acceptable transparency and low visible colouration despite the excellent infrared absorption. Previous efforts to date have not provided sufficiently infrared absorbent, yet suitably transparent, window coatings for detectability by such sensors.

In some embodiments of the first and second aspects the particles of doped or Magnéli phase tungsten oxide are present at a loading of between about 0.12 g/m² and about 1.2 g/m², preferably between about 0.5 g/m² and about 0.75 g/m².

In some embodiments of the first and second aspects the particles of doped or Magnéli phase tungsten oxide are present at a loading sufficient to absorb at least 20% preferably at least 25%, such as at least 30%, of an intensity of at least one wavelength of infrared radiation, preferably near infrared radiation, when light comprising the infrared radiation is transmitted through the window.

In some embodiments of the first and second aspects the window is an edge window, such as an edge-to-edge window. Such large windows are increasingly popular in bank note design, yet present increased challenges for detectability of the bank notes due to the increased transparent area. In some embodiments of the first and second aspects the substrate is a transparent polymeric substrate.

In some embodiments of the first and second aspects, the infrared-absorbent composition is coated on the window in a transparent coating. The transparent coating may entirely cover the window on at least one side. The transparent coating may comprise a matrix of a transparent varnish or binder.

In some embodiments the transparent coating further comprises metal oxide nanoparticles at a loading sufficiently high to provide a contrast between a refractive index of the coating and a refractive index of the substrate or any surface relief layer thereon. In some such embodiments, the coating fills three-dimensionally structured formations of a surface relief layer on the substrate, wherein the contrast maintains a visible optical effect of the formations. The metal oxide nanoparticles are preferably not particles of a tungsten oxide. The metal oxide nanoparticles may suitably comprise at least one of titanium dioxide, zirconium dioxide, zinc oxide, tin oxide and cerium oxide. The metal oxide nanoparticles may comprise at least one of titanium dioxide and zirconium dioxide.

The inclusion of the metal oxide nanoparticles to increase the refractive index of the coating may advantageously allow a visible optical effect, such as a diffractive effect, of the formations to be retained while still allowing the infrared absorbency and transparency of the window coating to be retained.

In some embodiments of the second aspect, the infrared radiation comprises near-infrared radiation.

In some embodiments of the second aspect, detecting the infrared radiation comprises measuring an intensity of the infrared radiation transmitted through or reflected by the window or a security device thereon. In some such embodiments, detecting the infrared radiation comprises measuring an intensity of the infrared radiation transmitted through the window. As used herein, the intensity of the infrared radiation may be measured as an absolute intensity, or as an intensity of the infrared radiation relative to other wavelength components of the light.

In accordance with a third aspect the invention provides a security device on a substrate for a security document, the security device comprising: three-dimensionally structured formations in a surface relief layer on the substrate; and a transparent coating which fills the formations of the surface relief layer, wherein: a) at least one of the surface relief layer and the coating comprises an infrared-absorbent composition comprising particles of doped or Magnéli phase tungsten oxide; and b) one of the surface relief layer and the coating comprises metal oxide nanoparticles at a loading sufficiently high that a contrast between a refractive index of the coating and a refractive index of the surface relief layer maintains a visible optical effect of the formations.

The inclusion of both the infrared-absorbent composition and the metal oxide nanoparticles in the same security device, according to the invention, may advantageously increase the overall security level of the security device, as the device may exhibit both visible optical effects and a covert infrared detectable feature. Alternatively or additionally, the visible optical effect of the security device may be provided on a window of a bank note, with the infrared-absorbent composition allowing improved detection of the bank note using certain infrared scanners. Furthermore, the transparent coating may protect the formations responsible for the visible optical effect from physical damage and fraudulent mechanical lifting.

In accordance with a fourth aspect the invention provides a method of producing a security device on a substrate for a security document, the method comprising: producing three-dimensionally structured formations in a surface relief layer on the substrate; and producing a transparent coating which fills the formations of the surface relief layer, wherein: a) at least one of the surface relief layer and the coating comprises an infrared-absorbent composition comprising particles of doped or Magnéli phase tungsten oxide; and b) one of the surface relief layer and the coating comprises metal oxide nanoparticles at a loading sufficiently high that a contrast between a refractive index of the coating and a refractive index of the surface relief layer maintains a visible optical effect of the formations.

In some embodiments of the third and fourth aspects the substrate is a transparent polymeric substrate. The security device may be on a window of the security document.

In some embodiments of the third and fourth aspects, the substrate is an opaque polymeric substrate. An example of an opaque polymeric substrate is provided in applicant's Australian patent application 2017901840, the contents of which are incorporated herein by reference.

In some embodiments of the third and fourth aspects the coating comprises the infrared-absorbent composition comprising particles of doped or Magnéli phase tungsten oxide, and the coating also comprises the metal oxide nanoparticles.

In other embodiments of the third and fourth aspects the surface relief layer comprises the infrared-absorbent composition comprising particles of doped or Magnéli phase tungsten oxide, and the coating comprises the metal oxide nanoparticles.

In some embodiments of the third and fourth aspects the particles of doped or Magnéli phase tungsten oxide are present at a loading of between about 0.12 g/m² and about 1.2 g/m², preferably between about 0.5 g/m² and about 0.75 g/m².

In some embodiments of the third and fourth aspects, the particles of doped or Magnéli phase tungsten oxide are present at a loading sufficient to absorb at least 20%, preferably at least 25%, such as at least 30%, of an intensity of at least one wavelength of infrared radiation, preferably near infrared radiation, when light comprising the infrared radiation is transmitted through the security device.

In some embodiments of the third and fourth aspects the optical effect is a diffractive effect.

In some embodiments of the third and fourth aspects the metal oxide nanoparticles are not particles of a tungsten oxide. The metal oxide nanoparticles may suitably comprise at least one of titanium dioxide, zirconium dioxide, zinc oxide, tin oxide and cerium oxide. The metal oxide nanoparticles may comprise at least one of titanium dioxide and zirconium dioxide.

In some embodiments of the third and fourth aspects the coating comprises a matrix of a transparent varnish or binder. In some embodiments of the third and fourth aspects, the metal oxide nanoparticles are dispersed in a transparent matrix throughout a thickness of the surface relief layer or the coating.

In some embodiments of the fourth aspect producing three-dimensionally structured formations in a surface relief layer on the substrate comprises applying a embossable lacquer coating to the substrate and then simultaneously embossing and curing the lacquer coating. In some embodiments of the fourth aspect, producing the coating comprises applying a coating composition onto the surface relief layer, for example via gravure printing. As required, the embossable lacquer coating and the coating composition may suitably comprise the particles of doped or Magnéli phase tungsten oxide and/or the metal oxide nanoparticles prior to the application.

In accordance with a fifth aspect the invention provides a security device on a polymeric substrate for a security document, the security device comprising a plurality of layers at least partially overlaid on the substrate, wherein: at least one of the layers comprises an opacifying pigment; at least another of the layers comprises an infrared-absorbent composition comprising particles of doped or Magnéli phase tungsten oxide; and the layers are overlaid such that contrast areas on the substrate having visually contrasting densities of the pigment and/or the infrared-absorbent composition produce a shadow image.

As a result of the at least one infrared-absorbent layer thus integrated into a shadow image device, a security document including the security device may have improved security. The shadow image with visible variation in pigment density or colouration provides an attractive and secure visible design feature in natural light, while the security device may be inspected by an infrared scanning device, such as an infrared camera, to authenticate the document by revealing a covert feature under infrared radiation.

The inventors have surprisingly found that an infrared-absorbent composition comprising particles of doped or Magnéli phase tungsten oxide is sufficiently absorbent of infrared radiation to allow opacified areas on a security document covered with the composition to be distinguished from adjacent opacified areas lacking the composition, despite the presence of the opacification pigment. Typical opacified regions on transparent polymeric substrates contain multiple opacification layers to provide similar visible opacities to paper bank notes. It is thus surprising that such opacified regions are sufficiently transparent to infrared absorption to allow a covert infrared-absorption image to be visualised under infrared radiation.

In accordance with a sixth aspect the invention provides a method of producing a security device on a polymeric substrate for a security document, the method comprising applying a plurality of layers onto the substrate such that the layers are at least partially overlaid, wherein: at least one of the layers comprises an opacifying pigment; at least another of the layers comprises an infrared-absorbent composition comprising particles of doped or Magnéli phase tungsten oxide; and the layers are overlaid such that contrast areas on the substrate having visually contrasting densities of the pigment and/or the infrared-absorbent composition produce a shadow image.

In some embodiments of the fifth and sixth aspects the shadow image is produced within an opacified region of the security document formed by one or more of the layers comprising the pigment which are continuously coated over the opacified region. In some embodiments, at least two, or at least three, or at least four, such as five, of the layers comprising the pigment are continuously coated over the opacified region.

In some embodiments of the fifth and sixth aspects the infrared-absorbent composition produces a covert image viewable by an infrared camera when the security device is irradiated with light comprising at least infrared radiation.

In some embodiments of the fifth and sixth aspects at least two of the layers comprise the infrared-absorbent composition and are overlaid such that contrasting densities of the infrared-absorbent composition on the substrate produce the covert image as a multi-tonal image.

In some embodiments of the fifth and sixth aspects at least one of, and optionally each of, the layers comprising the infrared-absorbent composition further comprises the pigment.

In some embodiments of the fifth and sixth aspects the contrast areas on the substrate have visually contrasting densities of the pigment. In these or other embodiments the contrast areas on the substrate have visually contrasting densities of the infrared-absorbent composition.

In some embodiments of the fifth and sixth aspects at least one of the layers is selectively present over at least one of the contrast areas which thereby has a higher density of the pigment and/or the infrared-absorbent composition than a surrounding contrast area, whereby the shadow image is a positive shadow image. In other embodiments at least one of the layers is selectively omitted over at least one of the contrast areas which thereby has a lower density of the pigment and/or the infrared-absorbent composition than a surrounding contrast area, whereby the shadow image is a negative shadow image.

In some embodiments of the fifth and sixth aspects the particles of doped or Magnéli phase tungsten oxide are present at a loading of between about 0.12 g/m² and about 1.2 g/m², preferably between about 0.5 g/m² and about 0.75 g/m², in at least one, and optionally each of the layers comprising the infrared-absorbent composition.

In some embodiments of the fifth and sixth aspects the particles of doped or Magnéli phase tungsten oxide are present at a loading sufficient that at least 70% of an intensity of at least one wavelength of infrared radiation, preferably near infrared radiation, is absorbed when light comprising the infrared radiation is transmitted through an area of the security device comprising the infrared-absorbent composition.

In some embodiments of the fifth and sixth aspects the opacifying pigment comprises particulate titanium dioxide with a particle size of from 200 to 400 nm.

In some embodiments of the fifth and sixth aspects the substrate is a transparent polymeric substrate. In some embodiments the substrate may be an opaque polymeric substrate. An example of an opaque polymeric substrate is provided in applicant's Australian patent application 2017901840, the contents of which is incorporated herein by reference.

In some embodiments of the sixth aspect applying the plurality of layers onto the substrate comprises applying sequential layers of a coating composition onto the substrate, for example via gravure printing. As required, the coating composition may suitably comprise the particles of doped or Magnéli phase tungsten oxide and/or the pigment dispersed in a resin or binder prior to the application. After each application, the coating compositions may be dried and/or cured.

In accordance with a seventh aspect the invention provides a method of inspecting a security document according to the fifth aspect, the method comprising: irradiating the security device with light comprising at least infrared radiation; and detecting the infrared radiation transmitted through or reflected by the security device.

In some embodiments of the seventh aspect the infrared radiation comprises near-infrared radiation.

In some embodiments of the seventh aspect detecting the infrared radiation comprises viewing a covert image produced by the infrared-absorbent composition with an infrared camera. In some such embodiments, the covert image is produced by infrared radiation reflected by the security device.

In accordance with an eighth aspect the invention provides a security document comprising an opacified region, the security document comprising a polymeric substrate; and a plurality of layers at least partially overlaid on the opacified region of the substrate, wherein: at least one of the layers comprises an infrared-absorbent composition comprising particles of doped or Magnéli phase tungsten oxide; and at least another of the layers comprises an opacifying pigment.

As a result of the at least one infrared-absorbent layer, the opacified region may be irradiated with infrared radiation and inspected by an infrared scanning device, such as an infrared camera, to authenticate the security document or to determine the presence or extent of wear or damage on the opacified region.

In some embodiments of the eighth aspect the particles of doped or Magnéli phase tungsten oxide are present at a loading of between about 0.12 g/m² and about 1.2 g/m², preferably between about 0.5 g/m² and about 0.75 g/m², in at least one, and optionally each layer comprising the particles.

In some embodiments of the eighth aspect at least two layers of the plurality comprise the particles of doped or Magnéli phase tungsten oxide, the at least two layers having different loadings of the particles. Optionally, the at least two layers may each also comprise the opacifying pigment.

In some embodiments of the eighth aspect the substrate is a transparent polymeric substrate. In other embodiments the substrate is an opaque polymeric substrate. An example of an opaque polymeric substrate is provided in applicant's Australian patent application 2017901840, the contents of which is incorporated herein by reference.

In some embodiments of the eighth aspect each layer of the plurality comprises the opacifying pigment. Typically, at least one of the layers comprising the opacifying pigment is continuously coated over the opacified region. In some embodiments, at least two, or at least three, or at least four, such as five, of the layers comprising the pigment are continuously coated over the opacified region.

In some embodiments of the eighth aspect the opacifying pigment comprises particulate titanium dioxide. The particulate titanium dioxide may have a particle size of from 200 to 400 nm.

In some embodiments of the eighth aspect the layers comprise a transparent polymeric matrix or binder.

In some embodiments of the eighth aspect the security document is a bank note with suspected wear or damage on the opacified region, for example a used bank note.

In accordance with a ninth aspect the invention provides a method of inspecting a security document according to the eighth aspect, the method comprising: irradiating the opacified region with light comprising at least infrared radiation; and detecting the infrared radiation transmitted through or reflected by the opacified region.

In some embodiments of the ninth aspect the infrared radiation comprises near-infrared radiation.

In some embodiments of the ninth aspect detecting the infrared radiation comprises viewing the infrared radiation transmitted through or reflected by the opacified region with an infrared camera.

In some embodiments of the ninth aspect detecting the infrared radiation comprises measuring an intensity of the infrared radiation reflected by at least one surface portion of the opacified region. In some such embodiments, the method further comprises determining which of the plurality of layers is exposed at the at least one surface portion of the opacified region by comparing the intensity against predetermined ranges characteristic of the layers.

In some embodiments of the first to ninth aspects, the doped or Magnéli phase tungsten oxide is a doped tungsten oxide, such as a caesium-doped tungsten oxide. In some embodiments, the caesium-doped tungsten oxide has a formula of CsₓWO₃, wherein x is between 0.2 and 0.4, such as about 0.33. The caesium-doped tungsten oxide may thus be CS_{0.33}WO₃.

In some embodiments of the first to ninth aspects, the particles of doped or Magnéli phase tungsten oxide have an average particle size of below about 1000 nm, or below about 350 nm, or below about 200 nm, such as below about 100 nm.

In some embodiments of the first to ninth aspects, the security document is a substrate of a bank note. In some embodiments the security document is a bank note.

Where the terms “comprise”, “comprises” and “comprising” are used in the specification (including the claims) they are to be interpreted as specifying the stated features, integers, steps or components, but not precluding the presence of one or more other features, integers, steps or components, or group thereof.

Further aspects of the invention appear below in the detailed description of the invention.

### BRIEF DESCRIPTION OF DRAWINGS

Embodiments of the invention will herein be illustrated by way of example only with reference to the accompanying drawings in which:

FIG. 1 schematically depicts in plan view a bank note comprising a transparent window, according to an embodiment of the invention.

FIG. 2 schematically depicts the bank note of FIG. 1, in side cutaway view taken through section line A-B depicted in FIG. 1, positioned between the radiation source and infrared detector of a machine for processing or inspecting bank notes.

FIG. 3 schematically depicts in side cutaway view a bank note comprising a transparent window, according to another embodiment of the invention, positioned between the radiation source and infrared detector of a machine for processing or inspecting bank notes.

FIG. 4 schematically depicts in side cutaway view a security device on a bank note substrate, according to another embodiment of the invention.

FIG. 5 schematically depicts in plan view a shadow image security device on a bank note substrate, according to another embodiment of the invention.

FIGS. 6A through 6D schematically depicts a method for producing the shadow image security device of FIG. 5, according to another embodiment of the invention.

FIG. 7 schematically depicts in plan view a shadow image security device on a bank note substrate, according to another embodiment of the invention.

FIG. 8 schematically depicts the shadow image security device of FIG. 7, in side cutaway view taken through section line A-B depicted in FIG. 7.

FIG. 9 schematically depicts in plan view a shadow image security device on a bank note substrate, according to another embodiment of the invention.

FIG. 10 schematically depicts the shadow image security device of FIG. 9, in side cutaway view taken through section line A-B depicted in FIG. 9.

FIG. 11 schematically depicts in side cutaway view a shadow image security device on a bank note substrate, according to another embodiment of the invention.

FIG. 12 schematically depicts in side cutaway view a shadow image security device on a bank note substrate, according to another embodiment of the invention.

FIG. 13 schematically depicts in plan view a covert infrared security device detectable by irradiating the shadow image security device of FIG. 12 and viewing the device with an infrared camera.

FIG. 14 schematically depicts in side cutaway view a bank note comprising an opacified region according to another embodiment of the invention, positioned beneath a radiation source and infrared detector of a machine for assessing bank note wear, damage or manufacturing quality.

FIG. 15 schematically depicts in side cutaway view a bank note comprising an opacified region according to another embodiment of the invention.

FIG. 16 schematically depicts in side cutaway view a bank note comprising an opacified region and a transparent window according to another embodiment of the invention, positioned between a radiation source and infrared detector of a machine for processing or inspecting bank notes.

FIG. 17 depicts a photograph of a bank note according to another embodiment of the present disclosure, as it is inspected with a counterfeit detector.

FIG. 18 depicts a negative shadow image according to another embodiment of the present disclosure, as it is viewed in natural light conditions.

FIG. 19 depicts a photograph of a banknote including the negative shadow image of FIG. 18, as it is inspected with a counterfeit detector.

### DETAILED DESCRIPTION

### Definitions

### Security Document

As used herein, the term security document includes all types of documents of value and identification documents including, but not limited to the following: items of currency such as bank notes and coins, credit cards, cheques, passports, identity cards, securities and share certificates, driver's licences, deeds of title, travel documents such as airline and train tickets, entrance cards and tickets, birth, death and marriage certificates, and academic transcripts.

### Substrate

The use of plastic or polymeric materials in the manufacture of security documents pioneered in Australia has been very successful because polymeric banknotes are more durable than their paper counterparts and can also incorporate windows and other security features. The substrate may thus be a plastic or polymeric material including but not limited to polypropylene (PP), polyethylene (PE), polycarbonate (PC), polyvinyl chloride (PVC), polyethylene terephthalate (PET); or a composite material of two or more such materials.

In some embodiments, the substrate is a transparent polymeric material. A particularly suitable transparent substrate is polypropylene and in particular bi-axially oriented polypropylene.

In some embodiments, the substrate is an opaque polymeric substrate. Examples and methods of construction of such opaque polymeric substrate are for example provided in applicant's Australian patent application 2017901840. The opaque polymeric substrate is opacified during manufacture of the film itself by inclusion of an opacifying additive into the polymer during extrusion. That is, the polymer film is opacified due to its bulk properties rather than due to addition of opacifying layers. One such example of a suitable polymer film is a bi-axially oriented polypropylene (BOPP) which has titanium dioxide particles added during manufacture to create a white polymer film.

In some embodiments, the substrate is from 60 to 100 microns thick, preferably from 65 to 90 microns thick.

### Window

One common security feature in polymeric banknotes produced for Australia and other countries is a transparent area or “window”. Bank notes produced on a transparent polymeric substrate typically comprise one or more pigmented coatings (opacification layers) to form opacified regions of the bank note. A window in the bank note is thus provided by leaving an area of the transparent bank note substrate free of the pigmented coatings.

Alternatively, a window may be produced in a paper bank note by including a transparent polymeric substrate as an insert in a cut out section of the opaque paper substrate.

As used herein, edge windows are windows which extend to an edge of the bank note, while edge-to-edge windows extend across the width of the bank note from one edge to the opposite edge. Larger-sized windows on bank notes, including edge and edge-to-edge windows, are increasingly popular as they increase the level of security.

### Opacification

The opacified regions of bank notes produced on a transparent polymeric substrate typically comprise at least one printed opacification layer, with printed design features or security features then applied on top. Typically, multiple overlaid opacification layers are sequentially printed to provide a suitable pigment density for opacification.

The opacification layers may comprise any opacifier which suitably opacifies the substrate, as perceived by a viewer. The opacifier is typically a pigment in the form of a particulate material, which is dispersed or bound in a polymeric matrix or binder. The pigment particles may optionally be coated or otherwise surface-modified to improve their dispersibility.

The opacification layers may comprise a pigment that is substantially non-absorbent of visible light, but which opacifies the substrate by scattering and/or refracting visible light. Unless other colouring agents are also included, transparent substrates overlaid with opacification layers of sufficient combined thickness and pigment density will appear white to a viewer when viewed in natural light, since a wide range of visible light wavelengths are substantially reflected from the substrate as a result of light scattering by the pigment particles.

Scattering (white) pigments generally have a high refractive index relative to the matrix in which they are dispersed. Furthermore, it will be appreciated that the particle size of the pigment affects scattering power. Refractive particles scatter light optimally when the primary particle size is approximately half the wavelength of the light. Since the human eye is most sensitive to yellow-green light, with a wavelength of around 550 nm, pigment particles with a particle size of 200-300 nm are considered optimal opacifiers in the art. The pigment particles may therefore have particle sizes predominantly in a range of from 150 nm to 500 nm, such as from 200 nm to 400 nm. Particles smaller than about 100 nm may be too small to effectively scatter visible light.

A particularly suitable pigment for opacification of film substrates according to the invention is particulate titanium dioxide, preferably with a high content of rutile phase (although anatase is also considered to be effective). Rutile titanium dioxide has a higher refractive index (2.73) compared with many other white pigments. Although titanium dioxide is thus preferred, other opacifier pigments such as antimony oxide, zinc oxide, calcium carbonate, magnesium silicate (talc) and the like may also be used.

### Security Device or Feature

As used herein, the term security device or feature includes any one of a large number of security devices, elements or features intending to protect a security document or token from counterfeiting, copying, alteration or tampering. Security devices or features may be provided in or on the substrate of the security document, including in one or more layers applied to the base substrate. A security document substrate may thus be functionalised with security features by any suitable techniques, including coating, embossing, printing, adhesion, hot stamping and the like. Security features may take a wide variety of forms such as security threads embedded in layers of the security document; security inks such as fluorescent, luminescent or phosphorescent inks, metallic inks, iridescent inks, photochromic, thermochromic, hydrochromic, or piezochromic inks; printed or embossed features including release structures; interference layers; liquid crystal devices; lenses and lenticular structures; optically variable devices (OVDs) such as diffractive devices including diffraction gradients, holograms and diffractive optical elements (DOEs).

### Shadow Images

On polymer-based security documents such as bank notes, a shadow image is considered the equivalent to a watermark on a paper bank note. A shadow image, visible to a viewer in natural light in the form of an indicia, symbol or pattern, is produced by variations in pigment density or colouration between visually contrasting areas (contrast areas hereafter) on the surface of the polymeric substrate. A shadow image may be produced in an opacified region of polymeric bank notes by selective printing of some of the pigmented opacification layers on the substrate.

A positive shadow image generally includes additional opacification layers selectively present beneath, intermediate or over the other opacification layer(s), such that an indicia, symbol or pattern appears darker (more opaque, or with subtly different colouration) against a lighter (less opaque, or whiter) background. Conversely, a negative shadow image generally includes areas in which one or more of the opacification layers is selectively omitted, such that an indicia, symbol or pattern appears lighter against a darker background.

### Surface Relief Layers

Some security devices include a surface relief layer formed on a surface of the substrate, frequently in a window of a bank note. The surface relief layer comprises three-dimensionally structured formations, which are typically optically active. For example, a relief layer may comprise diffractive structures such as DOEs, diffraction gratings and holograms and non-diffractive optically variable devices, including those comprising focusing elements such as micro-lenses and structured micro-imagery for viewing through such elements.

To produce such surface relief layers, a transparent, radiation-curable lacquer is typically applied as a coating to the polymeric substrate. The lacquer is then embossed with a shim or roller having a three-dimensional surface microstructure, and simultaneously cured with UV-radiation to produce a micro-structured relief layer adhered to the substrate. However, other methods of producing microstructured surface relief layers are available, including hot-embossing a structure into a thermally-activated substrate or surface layer on the substrate, or by transferring and adhering lacquer formations from a micro-structured printing surface onto the substrate.

The present invention relates to a security documents, and security devices on such documents, which include an infrared-absorbent composition comprising particles of doped or Magnéli phase tungsten oxide which absorb strongly in the near-infrared spectrum of light, but only weakly in the visible spectrum. The inventors have discovered that these properties may be exploited to enhance the security of security documents and/or to facilitate machine-assisted processing or screening of security documents. Thus, parameters such as authenticity, wear, damage, manufacturing quality, location within a machine and numerical count of security documents such as bank notes may be determined by methods including a step of irradiating the document with light, and imaging a covert infrared feature or measuring the intensity (absolute, or relative to other spectral components) of the infrared radiation reflected by, or transmitted through, the security document.

### Particles of Doped or Magnéli Phase Tungsten Oxide

The infrared-absorbent compositions of the invention comprise doped or Magnéli phase tungsten oxide particles. Unmodified crystalline tungsten trioxide (WO₃) is substantially non-absorptive in the near-infrared light spectrum. However, modification of tungsten oxide by doping with a variety of elements, or by reducing the oxygen content to produce a Magnéli phase, introduces free electrons into the material, reorders the crystalline structure and lowers the band gap. Such materials may exhibit conductive properties and a strong absorption in the near-infrared light spectrum.

Suitable doped tungsten oxides may comprise dopant ions such as H⁺, Li⁺, Na⁺, KC⁺, Rb⁺, Cs⁺, Ag⁺, Tl⁺, which produce a tungsten bronze type crystalline structure in the material. Suitable Magnéli phase tungsten oxides may have a formula WO_{z}, where 2.45≤z<3. Generally, suitable particles of doped and Magnéli phase tungsten oxides are those which absorb strongly in the near-infrared spectrum (700 to 2500 nm, preferably 700 to 1000 nm) relative to the absorption in the visible spectrum (350-700 nm). It is not required that the oxides are completely transparent to visible light, since the materials may be effective at loadings where any colouration produced by the particles is acceptably low. The particles may be prepared by disclosed methods available to the skilled person or are available as items of commerce, and their performance in the security documents, security devices and methods of the invention may be evaluated with routine spectrophotometric methods.

In some embodiments, the particles are doped tungsten oxide particles where the dopant comprises caesium. A suitable caesium-doped tungsten oxide may have the formula CsₓWO_{y}, wherein 0.01≤x≤1 and 2.2≤y≤3. In some embodiments, 0.2≤x≤0.4 and y is approximately 3. In some embodiments, the caesium-doped tungsten oxide has a hexagonal structure. A particularly suitable caesium-doped tungsten oxide is Cs_{0.33}WO₃. This material absorbs strongly in the near-infrared spectrum (700-1000 nm) while absorbing only very weakly in the visible light spectrum, thus being of relatively low colouration.

In some embodiments, the particles of doped or Magnéli phase tungsten oxide have an average particle size of below 1000 nm. The particles may be between about 50 nm and about 500 nm. In some embodiments, the particles have an average particle size of about 300 nm. Smaller particles may be preferred in some embodiments due to their reduced propensity for scattering visible light. In some embodiments, the particles may have a particle size of below about 350 nm, or below about 200 nm, such as below about 100 nm.

The infrared-absorbent composition may in certain embodiments consist of the doped or Magnéli phase tungsten oxide particles. However, it is not excluded that other suitably infrared-absorbent materials may be used to supplement the properties of the doped or Magnéli phase tungsten oxide particles.

### Coatings and Coating Compositions

The infrared-absorbent compositions are typically present in one or more layers or coatings on the substrate of the security document. The doped or Magnéli phase tungsten oxide particles are generally present in the coating in a transparent polymeric matrix. The matrix may comprise one or more polymeric components selected from a varnish, a binder, a dispersing aid, a cured (i.e. cross-linked) resin, including an acrylic-based UV-cured resin. In some embodiments, as will be described hereafter, the coatings may comprise additional particulate materials dispersed together with the doped or Magnéli phase tungsten oxide particles. Coatings on security documents such as bank notes generally have a thickness in the range of about 100 nm to about 3 microns.

Coatings or layers, including those comprising the infrared-absorbent compositions, may be applied to the substrate as a coating composition (or ink) by any suitable printing or coating process. The coating composition may include the binder, resin etc (or cross-linkable precursors thereof), cross-linking agents, dispersants and organic solvents, together with the particulate components. In some embodiments, the coatings are applied via a printing technique such as gravure printing. The coating compositions may then be dried or cured (e.g. thermally, or via curing radiation) as necessary. Where the coatings are applied to a web of the substrate in a roll-to-toll printing operation, as is common in the manufacturing of security documents, each of the coatings may be applied and/or cured at successive stations along the web.

### Machines for Processing or Inspecting Security Documents

The security documents and security features of the invention may be particularly suited for machine detection or inspection, and methods of detecting or inspecting security documents are thus provided which include a step of irradiating the document with light, and measuring or imaging the absolute or relative intensity of the infrared radiation component reflected by, or transmitted through, the document. The methods are generally conducted in a machine for processing or inspecting security documents such as bank notes.

Such machines may include automatic teller machines (ATM), bank note counters, bank note acceptors (such as on vending machines), machines for verifying the authenticity of banks notes under irradiation (including at least infrared radiation) and machines for inspecting and/or sorting bank notes based on criteria such as wear, damage, manufacturing quality or authenticity.

Machines for processing or inspecting bank notes according to the invention comprise a radiation source and a radiation detector (such as an intensity detector or a camera). The radiation source irradiates a security document with radiation including at least infrared radiation component, and the detector measures, images or otherwise detects at least the infrared radiation transmitted through or reflected by the security document. The machine may include a data processor for processing the detected intensity of infrared radiation, for example as a visible light image on a display or by comparing a measured intensity against predetermined metrics.

### DESCRIPTION OF EMBODIMENTS

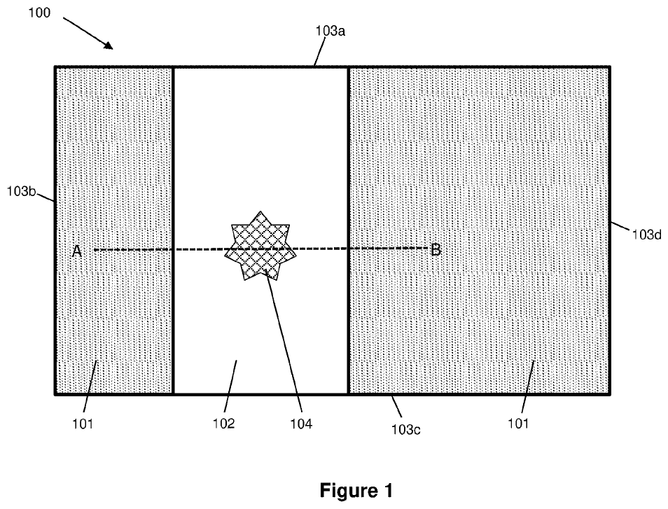

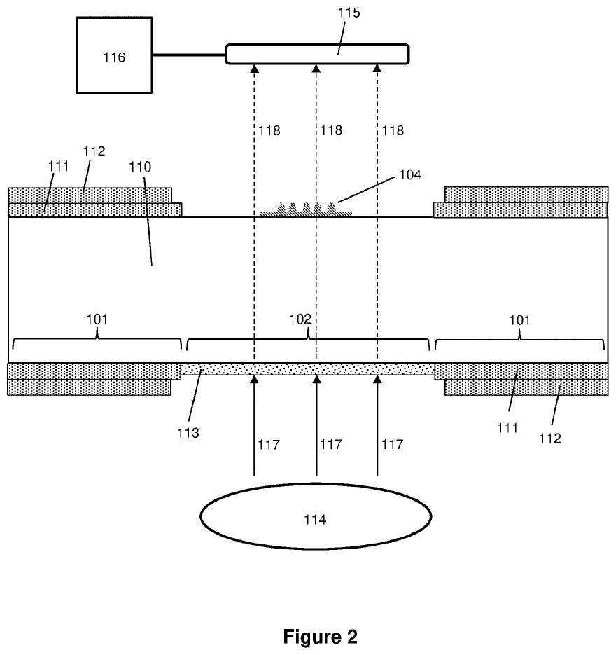

An embodiment of the invention will now be described with reference to FIGS. 1 and 2. FIG. 1 depicts bank note 100, including opacified regions 101 and edge-to-edge transparent window 102, and having four edges 103a-d. Optically variable security device 104 may optionally be formed on window 102. FIG. 2 depicts bank note 100 in side cutaway view, taken through the line A-B depicted in FIG. 1. Bank note 100 comprises transparent polymeric substrate 110 and opacification layers 111 and 112 on both sides of the substrate, which form opacified regions 101. Infrared-absorbent coating 113, present as a substantially transparent coating covering one face of window 102, comprises particles of caesium-doped tungsten oxide having an average particle size of 300 nm in a polymeric matrix.

As a result of infrared-absorbent coating 113, bank note 100 may be readily processed in a machine, such as an automatic teller machine (ATM), a bank note counter, a bank note acceptor or the like, which includes an infrared radiation scanning device for ascertaining the presence and/or relative position of bank notes in the machine. Also depicted in FIG. 2 is infrared radiation source 114 and infrared detector 115 coupled to a data processor 116, as may be found in such machines. As bank note 100 passes between radiation source 114 and detector 115, near-infrared radiation 117 falls incident on infrared-absorbent coating 113 and is at least partially absorbed thereby. Transmitted radiation 118 is detected by detector 115, and the partial or complete loss in intensity of radiation 118 as a result of the absorption is assessed by data processor 116 as indicative of the presence of the bank note.

It will be appreciated that the particles of caesium-doped tungsten oxide in the coating should be present at a loading such that the absorption of near-infrared radiation 117 is sufficient to be readily detectable by detector 115 and data processor 116. For example, at least 30% of the intensity of at least one wavelength of near-infrared radiation should be absorbed when light including the infrared radiation is transmitted through the window via the coating. However, the loading should not be too high, as the particles are not completely non-absorptive in the visible light spectrum and may thus contribute a blue coloured tinge to the coating at higher loadings. A suitable loading to provide an adequately transparent coating with suitable infrared absorption may be between about 0.12 g/m² and about 1.2 g/m², such as between about 0.5 g/m² and about 0.75 g/m².

In some embodiments the absorption of near-infrared radiation 117 incident on window 102 by infrared-absorbent coating 113 may be useful for determining a quantity or quality of bank notes. Thus, for example, detector 115 may be able to distinguish between a single bank note 100 and two or more such bank notes which are stuck together. In the latter case, the intensity of the transmitted radiation 118 will be sufficiently reduced that data processor 116 will recognise a fault. Furthermore, if the thickness of the coating and the loading of caesium-doped tungsten oxide particles is maintained within narrow specifications during manufacture, the intensity of the transmitted radiation 118 may be used as an indicator of manufacturing quality or of bank note wear in circulation.

Since infrared-absorbent coating 113 coats the entire window 102, the position of bank note 100 may be determined with accuracy even if window 102 is large and the leading edge of bank note 100 as conveyed through the machine is edge 103a or 103c, which include a window portion. In these circumstances, data processor 116 will accurately recognise the loss of intensity of radiation 118 as the leading edge of window 102 breaks radiation 117. With the position of the bank note thus accurately ascertained, the infrared radiation scanning device or other sensors in the machine may be used to inspect bank note 100 for quality and/or authenticity, or the machine may accurately count or dispense multiple bank notes 100.

Although it is preferred that infrared-absorbent coating 113 covers the entire window as described herein, it is also contemplated that an incomplete coating of the window may suffice, for example a strip along the leading edges of window 102. It will also be appreciated that infrared-absorbent coating 113 may be coated on one or both of the faces of substrate 110 at window 102. Moreover, it is envisaged that—instead of coating the window—the particles of caesium-doped tungsten oxide may be dispersed in the polymeric matrix of transparent substrate 110 such that the substrate itself becomes infrared absorbent. This may be achieved, for example, by adding the particles during melt processing of the base polymer before or during extrusion into film.

A process for producing bank note 100 may include a step of applying a coating composition comprising the particles of caesium-doped tungsten oxide in a carrier fluid with binder onto transparent polymeric substrate 110 at the window 102, for example via gravure printing. The coating composition may then be cured and/or dried to produce infrared-absorbent coating 113.

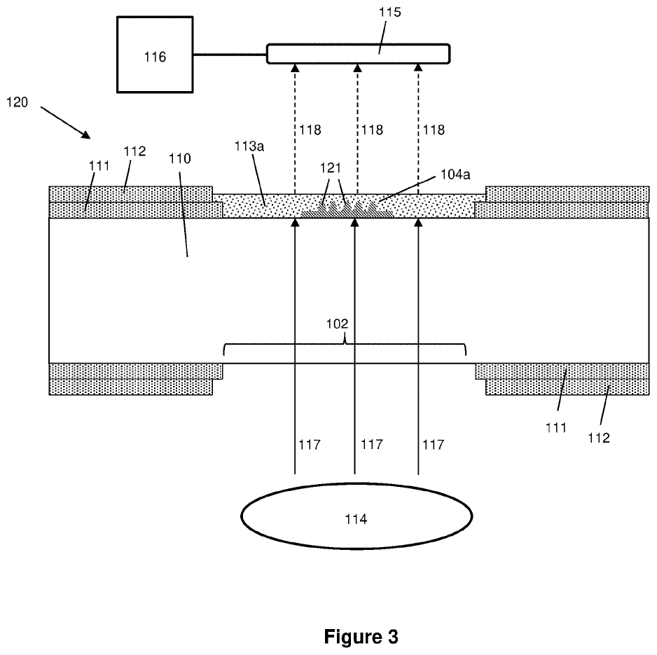

Another embodiment of the invention will now be described with reference to FIG. 3, which depicts bank note 120 positioned between infrared radiation source 114 and infrared detector 115 of a machine for processing bank notes. Features similarly numbered as those in FIG. 2 are as described for bank note 100.

Bank note 120 comprises security device 104a on window 102. Security device 104a is an optically variable device, for example a diffractive device such as a diffraction grating, a hologram or a diffractive optical element (DOE), comprising optically active, three-dimensionally structured formations 121 in a surface relief layer on substrate 110. Alternatively, formations 121 may form micro-lenses, or structured micro-image elements for viewing through such micro-lenses.

Infrared-absorbent coating 113a is present as a substantially transparent coating covering one face of window 102 and thus filling formations 121. Coating 113a comprises particles of caesium-doped tungsten oxide having an average particle size of 300 nm in a polymeric matrix. As such, window 102 of bank note 120 is detectable in a bank note processing machine comprising infrared radiation source 114 and infrared detector 115 coupled to data processor 116, as described herein for bank note 100.

By filling three-dimensionally structured formations 121, coating 113a also protects security device 104a from physical damage and prevents fraudulent mechanical lifting of its relief structure. However, in order to maintain the visible optical effect of three-dimensionally structured formations 121, it is necessary to provide a contrast in refractive index between coating 113a and formations 121 of the surface relief layer. Coating 113a thus further comprises nanoparticles of zirconium dioxide, i.e. particles having a primary crystallite size of below 100 nm. The nanoparticles are generally dispersed, together with the larger particles of caesium-doped tungsten oxide, in the polymeric matrix of the coating. Coating 113a is generally free of a high refractive index polymer. As a result of the zirconium dioxide nanoparticles, coating 113a is a high refractive index coating, i.e. it has a refractive index that is sufficiently higher than that of formations 121 that the visible optical effect produced by the formations is maintained. The loading of zirconium dioxide particles in coating 113a should be sufficiently high to provide a satisfactory contrast in refractive index. The refractive index of coating 113a may be above about 1.5.

Although zirconium dioxide nanoparticles have been exemplified herein, other metal oxide nanoparticles may be used as alternatives to, or in combination with, zirconium dioxide nanoparticles. Refractive metal oxides which are suitably non-absorptive in the visible (and generally also the near-infrared) regions of the electromagnetic spectrum include titanium dioxide, zirconium dioxide, zinc oxide, tin oxide and cerium oxide. Optionally, the nanoparticles may be surface-coated with inorganic or organic modifiers, including inorganic modifiers such as alumina, silica or other oxidic materials, and organic modifiers such as polyols, esters, siloxanes, silanes, carboxylic acids and the like.

It is generally required that the particles of the zirconium dioxide (or other suitable non-absorptive metal dioxide) for imparting high refractive index are nanometer scale particles (i.e. less than 100 nm). Larger particles (i.e. those over 100 nm) will increasingly scatter visible light (wavelengths of c.a. 400-700 nm) and thus render coating 113a opaque. The visible optical effect produced by formations 121 in the absence of coating 113a will thus be compromised, or lost altogether. In some embodiments, the primary crystallite size of the nanoparticles is thus from 5 to 25 nm.

A process for producing bank note 120 may include a step of applying a coating composition comprising both the particles of caesium-doped tungsten oxide and the nanoparticles of zirconium dioxide (or other suitable non-absorptive metal dioxide) onto window 102 such that the coating composition fills three-dimensionally structured formations 121 of security device 104a. The coating composition may be prepared by dispersing the nanoparticles of zirconium dioxide in a carrier fluid with binder, and thereafter adding the particles of caesium-doped tungsten oxide, optionally as a dispersion in a second carrier fluid. The coating composition may be applied via gravure printing, and then cured and/or dried to produce infrared-absorbent coating 113a.

As depicted in FIG. 3, polymeric substrate 110 is transparent, with security device 104 formed on a transparent window 102 that may be detected in transmission due to the infrared absorption of coating 113a. However, substrate 110 may also be an opacified substrate. In this case, infrared-absorbent coating 113a may form a covert design feature viewable in reflection by an infrared camera when bank note 120 is irradiated with infrared radiation.

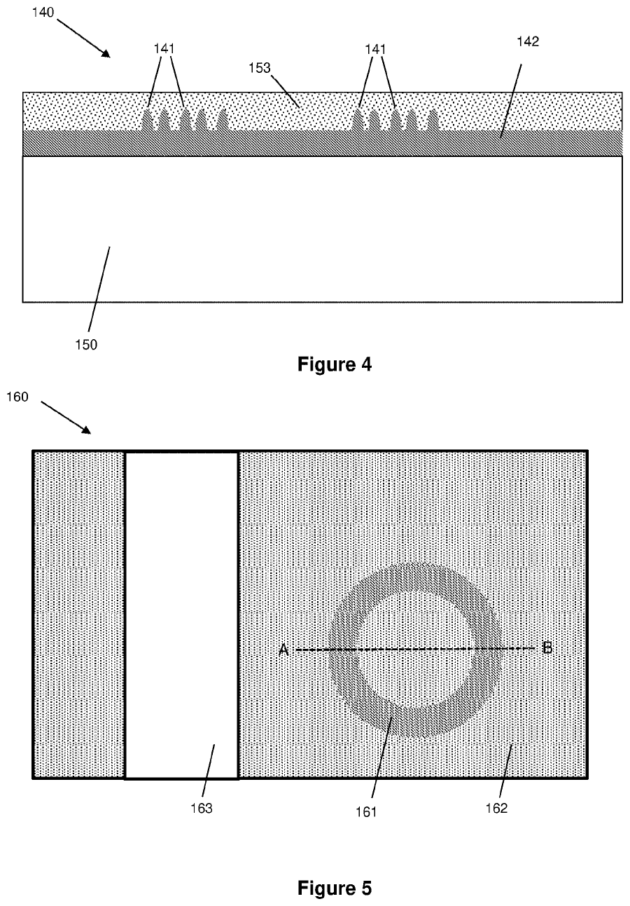

Another embodiment of the invention will now be described with reference to FIG. 4, which depicts security device 140 on transparent polymeric substrate 150 for a security document, for example on a window region. Security device 140 comprises three-dimensionally structured formations 141 formed in substantially transparent, polymeric surface relief layer 142. Depending on the configuration of formations 141, security device 140 may be an optically variable device, for example a diffractive device such as a diffraction grating, a hologram or a diffractive optical element (DOE). Alternatively, security device 140 may comprise formations 141 in the form of micro-lenses, or structured micro-image elements for viewing through such micro-lenses.

Surface relief layer 142 comprises particles of caesium-doped tungsten oxide having an average particle size of 300 nm in a polymeric matrix, and is thus an infrared-absorbent layer. The polymeric matrix may be a cured polymeric matrix, for example a matrix comprising a UV-cured, acrylic-based lacquer into which formations 141 are embossed. As a result of the dispersed caesium-doped tungsten oxide particles, security device 140 and/or surrounding areas of substrate 150 may be inspected by irradiating the security device with infrared radiation and detecting the radiation transmitted through or reflected by the device, as previously described herein.

Substantially transparent coating 153 is present on top of relief layer 142, thereby filling three-dimensionally structured formations 141. Coating 153 thus protects security device 140 from physical damage and prevents fraudulent mechanical lifting of its relief structure.

In order to maintain a visible optical effect of three-dimensionally structured formations 141, coating 153 comprises nanoparticles of zirconium dioxide, i.e. particles having a primary crystallite size of from 1 to 100 nm, typically dispersed in a polymeric matrix, and preferably dispersed throughout the thickness of coating 153. The primary crystallite size of the nanoparticles may be from 5 to 25 nm. Coating 153 is generally free of a high refractive index polymer. As a result of the zirconium dioxide nanoparticles, coating 153 is a high refractive index coating, i.e. it has a refractive index that is sufficiently higher than that of surface relief layer 142 such that the visible optical effect produced by formations 141 is maintained. The loading of zirconium dioxide nanoparticles in coating 153 should be sufficiently high to provide a satisfactory contrast in refractive index.

Although, as described herein, surface relief layer 142 comprises the particles of caesium-doped tungsten oxide, it will be appreciated that coating 153 may alternatively, or additionally, comprise the particles of caesium-doped tungsten oxide. Of importance is that security device 140 comprises a sufficient loading of these particles across the combined thickness of the two layers such that the security device is inspectable by an infrared detector when the device is irradiated with infrared radiation. A suitable total loading for this purpose may be between about 0.12 g/m² and about 1.2 g/m², such as between about 0.5 g/m² and about 0.75 g/m².

Furthermore, although coating 153 of security device 140 has been described as comprising the nanoparticles of zirconium dioxide, it will be appreciated that surface relief layer 142 may instead comprise these nanoparticles. In this case, surface relief layer 142 is the high refractive index layer and the loading of zirconium dioxide nanoparticles should be sufficiently high therein to provide a satisfactory contrast in refractive index against the lower refractive index of coating 153. Coating 153 may, in this embodiment, be a transparent varnish coating which lacks a particulate material dispersed through the matrix.

Since a contrast in refractive index is targeted, only one of surface relief layer 142 and coating 153 generally comprises the nanoparticles of zirconium dioxide, or other suitable non-absorptive metal oxide. The refractive index of the layer comprising the zirconium dioxide nanoparticles may be above about 1.5.

A process for producing security device 140 may include a step of producing three-dimensionally structured formations 141 in surface relief layer 142 on substrate 150. Formations 141 may be produced by suitable techniques disclosed in the art. For example, a layer of acrylic-based, UV-curable lacquer may be applied to substrate 150 by gravure printing, and the layer is then embossed with a microstructured shim or roller and simultaneously cured with UV radiation to produce formations 141. In embodiments where surface relief layer 142 comprises one or both of the particles of caesium-doped tungsten oxide and the nanoparticles of zirconium dioxide (or other suitable non-absorptive metal dioxide), the appropriate particles may be dispersed in the coating composition prior to application, embossing and curing.

A process for producing security device 140 may further include a step of applying a coating composition such that the coating composition fills three-dimensionally structured formations 141. The coating composition may be applied via gravure printing, and then cured and/or dried to produce coating 153. In embodiments where coating 153 comprises one or both of the particles of caesium-doped tungsten oxide and the nanoparticles of zirconium dioxide (or other suitable non-absorptive metal dioxide), the appropriate particles may be dispersed in the coating composition prior to application.

Both the relief layer comprising formations 141 and the coating 153 may be applied, embossed or cured (as required) onto a web of the substrate in a roll-to-roll printing operation at successive stations along the web.

Another embodiment of the invention will now be described with reference to FIG. 5, which depicts bank note 160 having shadow mark 161 on opacified region 162 of the substrate. Bank note 160 may optionally include window 163 and other security devices. Shadow mark 161 is a positive shadow image, where the “O”-shaped symbol appears as a region of greater opacity or stronger colouration in the opacification layer.

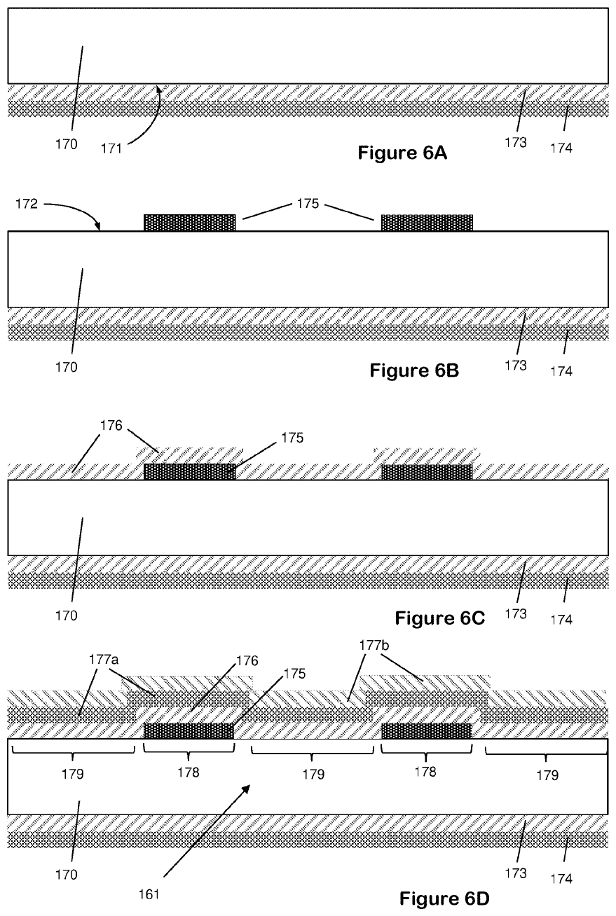

Shadow mark 161 is produced by applying a plurality of opacification layers to transparent polymeric substrate 170, as depicted schematically in side cutaway view (taken through line A-B in FIG. 5) in FIGS. 6A-6D. The opacification layers comprise titanium dioxide particles, with a particle size of 200 to 400 nm, as pigment, the particles being dispersed in a cross-linked polymeric binder. Each opacification layer may be applied by gravure printing a coating composition onto the substrate at a printing station. The coating composition may include the titanium dioxide particles, a cross-linkable polymeric binder and a catalyst to induce the cross-linking in a subsequent curing step. When the layers are printed onto a web of the substrate in a roll-to-roll printing operation, the layers may be printed onto the web at successive printing stations. Optionally, the base polymeric substrate may first be primed with a transparent primer layer to provide improved adhesion of the innermost opacification layers to substrate surfaces 171 and 172.

FIG. 6A depicts transparent biaxially oriented polypropylene substrate 170 already coated on first surface 171 with opacification layers 173 and 174. As seen in FIG. 6B, infrared-absorbent opacification layer 175 is then applied to second surface 172 at a gravure printing station. Layer 175 is selectively printed on surface 172 as an “O”-shaped ring, the layer thus being absent on areas of surface 172 inside and outside the ring.

Layer 175 comprises, in addition to the titanium dioxide pigment, particles of caesium-doped tungsten oxide having an average particle size of 300 nm in a polymeric matrix, and is thus an infrared-absorbent layer. The loading of the particles is such that absorption of near-infrared radiation is readily detectable by the infrared detector of a device for authenticating bank notes. A suitable loading may be between about 0.12 g/m² and about 1.2 g/m², such as between about 0.5 g/m² and about 0.75 g/m².

At the next printing station, opacification layer 176 is printed onto substrate 170, thus covering both layer 175 and surrounding areas of surface 172 as depicted in FIG. 6C. Finally, as seen in FIG. 6D, another two opacification layers 177a and 177b are sequentially printed onto substrate 170 over layer 176. Opacification layers 173, 174, 176, 177a and 177b are printed over, and thus form, the entire opacified region 162 depicted in FIG. 5.

Overlaid opacification layers 175, 176, 177a and 177b are arranged such that contrast areas 178 on surface 172 are covered by six opacification layers, while contrast areas 179 are covered by only five layers. The resultant difference in titanium dioxide pigment densities on the surface provides visually contrasting opacities, which produce a shadow image when security device 161 is observed by a viewer in natural light. In this embodiment, layer 175 is selectively present only in contrast areas 178, thereby providing a relatively high pigment density that contrasts against the lower opacity of other parts of opacified region 162. The viewer thus perceives a positive “O”-shaped shadow image, as seen in FIG. 5. The bluish colouration of the caesium-doped tungsten oxide particles in layer 175 may also contribute to the appearance of the shadow image.

Moreover, when bank note 160 is irradiated with infrared radiation and viewed in reflection or transmission with an infrared camera of a machine for authenticating banknotes, the security device will be detected as a dark “O”-shaped region, since contrast areas 178, covered by layer 175 in addition to layers 173, 174, 176, 177a and 177b, absorb a significantly greater portion of the incident infrared radiation than surrounding contrast areas 179 which are covered only by relatively infrared-transparent opacification layers 173, 174, 176, 177a and 177b. Contrast areas 178 may, for example, absorb at least 70% of the intensity of at least one wavelength of near-infrared radiation incident on the shadow image, as measured in transmission. Security device 161 thus combines both overt and covert security features, thereby improving the level of protection against counterfeiting.

As described herein, infrared-absorbent layer 175 comprises the titanium dioxide opacification pigment in addition to the particles of caesium-doped tungsten oxide, such that differing densities of the pigment contribute to the appearance of the shadow image. In other embodiments, however, layer 175 lacks opacification pigment but includes a sufficient loading of the blue-coloured caesium-doped tungsten oxide particles that a visible contrast in colouration between contrast areas 179 and white contrast areas 179 provides the shadow image.

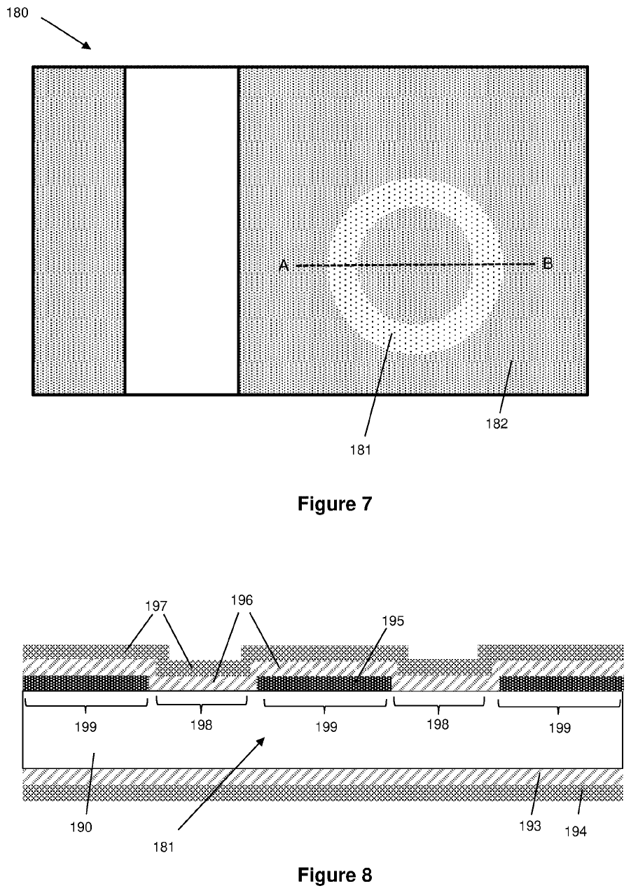

Another embodiment of the invention will now be described with reference to FIGS. 7 and 8, which depicts bank note 180 having shadow mark 181 on opacified region 182 of the substrate. Shadow mark 181 is a negative shadow image, where the “O”-shaped symbol appears as a region of greater transparency or lighter colouration in the opacification layer.

Shadow mark 181 is produced by a similar method as shadow mark 161. However, in this embodiment, innermost opacification layer 195, which otherwise covers opacified region 182 (contrast areas 199 in FIG. 8), is selectively omitted on the “0”-shaped ring (contrast areas 198 in FIG. 8).

Contrast areas 198 are thus covered by only two overlaid opacification layers on one surface (layers 196 and 197), while contrast areas 199 are covered by three layers (layers 195, 196 and 197). The resultant difference in titanium dioxide pigment densities on the surface provides visually contrasting opacities, which produce a shadow image when security device 181 is observed by a viewer in natural light. In this case, contrast areas 198 have a relatively low pigment density, i.e. relatively greater transparency, that contrasts against the higher opacity of other regions of opacified region 182. The viewer thus perceives a negative “O”-shaped shadow image, as seen in FIG. 7.

Layer 195 comprises, in addition to the titanium dioxide pigment, particles of caesium-doped tungsten oxide having an average particle size of 300 nm, and is thus an infrared-absorbent composition. Therefore, when bank note 160 is irradiated with infrared radiation and viewed in reflection or transmission with an infrared camera of a machine for authenticating banknotes, security device 181 will be detected as a light “O”-shaped region in a dark background, since opacified region 182 absorbs near-infrared radiation strongly except in contrast areas 198 where layer 195 is selectively omitted.

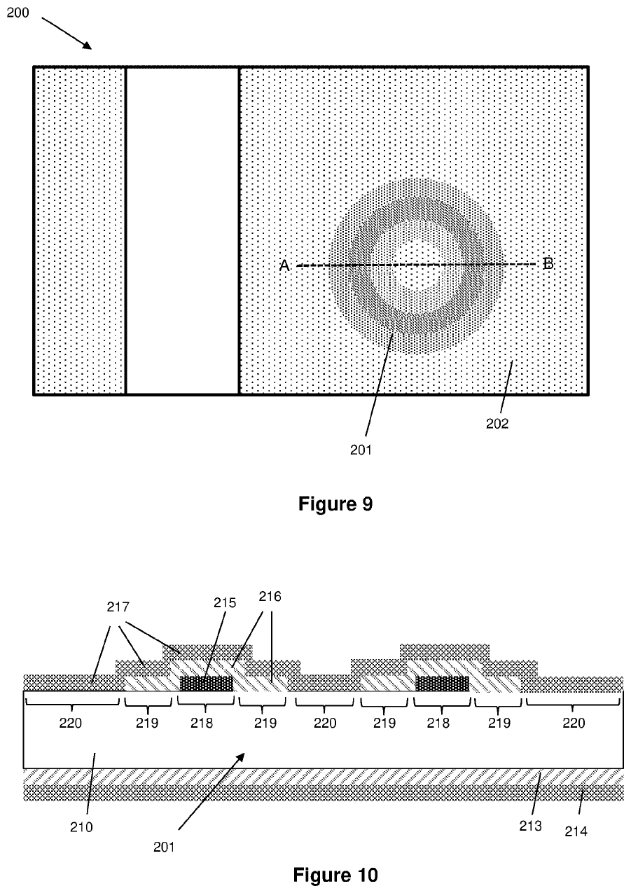

Another embodiment of the invention will now be described with reference to FIGS. 9 and 10, which depicts bank note 200 having shadow mark 201 on opacified region 202 of the substrate. Shadow mark 201 is a positive shadow image, where a multi-tonal “0”-shaped image appears as a region of greater opacity or darker colouration in the opacification layer.

Shadow mark 201 is produced by a similar method as shadow mark 161. However, in this embodiment, opacification layers 215 and 216 are selectively printed as concentric “O”-shaped rings of different line width on substrate 210, layer 215 being present on contrast areas 218 and overlying layer 216 being present on both contrast areas 218 and 219. Layers 215 and 216 are absent on other areas of opacified region 202 (contrast areas 220 in FIG. 10). Outermost opacification layer 217 is printed over the entire opacified region 202, including over layers 215 and 216. Layers 215 and 216 comprise, in addition to the titanium dioxide pigment, particles of caesium-doped tungsten oxide having an average particle size of 300 nm.

Overlaid opacification layers 215, 216 and 217 are thus arranged such that contrast areas 218 of one surface are covered by three opacification layers, contrast areas 219 are covered by two layers, and contrast areas 220 are covered by only one layer (i.e. excluding layers 213 and 214 on the opposite surface). The resultant difference in titanium dioxide pigment densities on the surface provides three visually contrasting opacities, which produce a positive, multi-tonal shadow image when security device 201 is observed by a viewer in natural light. The bluish colouration of the caesium-doped tungsten oxide particles in layers 215 and 216 may also contribute to the appearance of the shadow image in natural light.

Due to the particles of caesium-doped tungsten, both layers 215 and 216 are infrared-absorbent layers. The loading of caesium-doped tungsten oxide in each layer is selected such that near-infrared radiation incident on a single layer is incompletely absorbed. Thus, a greater proportion of radiation incident on contrast areas 218 will be absorbed than that of radiation incident on contrast areas 219, since contrast areas 218 have a higher total loading of the infrared-absorbent particles than contrast areas 219.

Therefore, when bank note 200 is irradiated with infrared radiation and viewed in reflection or transmission with an infrared camera of a machine for authenticating banknotes, security device 201 will be detected as a multi-tonal infrared image consisting of concentric “O”-shaped rings of different darkness against a light background, i.e. as a “shadow infrared image”. Thus, sophisticated overt and covert security features are provided on the bank note.

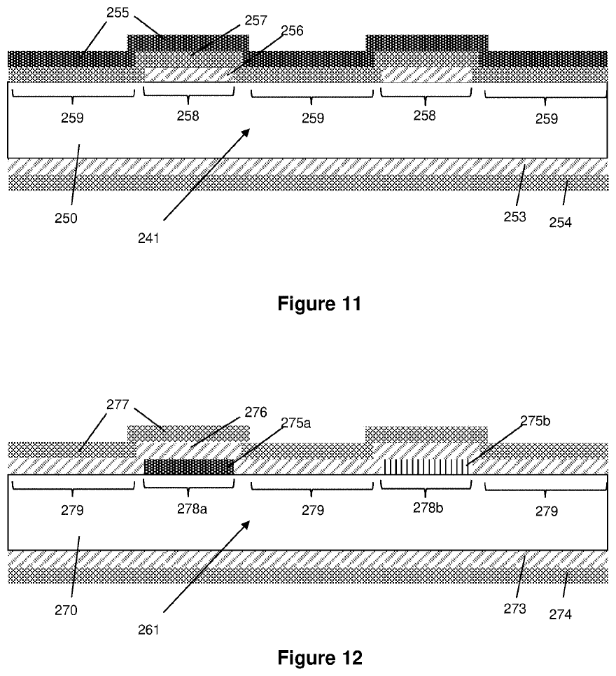

Another embodiment of the invention will now be described with reference to FIG. 11, which depicts shadow mark 241 on an opacified region of a bank note substrate in side cutaway view. Shadow mark 241 includes three titanium dioxide pigmented opacification layers 256, 257 and 255. Layer 256 is selectively printed as an “O”-shaped ring in contrast areas 258 on substrate 250, the layer thus being absent on contrast areas 259 inside and outside the ring. Layers 256 and 257 are then printed onto substrate 250, thus covering both layer 258 and surrounding areas of substrate 250. Layers 257 and 255, as well as opacification layers 253 and 254 on the opposite surface of substrate 250, are printed over the entire opacified region on the bank note.

The difference in titanium dioxide pigment densities in contrast areas 258, having three opacification layers on the substrate surface and contrast areas 259, having two opacification layers on the substrate surface, provides visually contrasting opacities, which produce a positive “O”-shaped shadow image when security device 241 is observed by a viewer in natural light, as similarly depicted in FIG. 5.

However, in this embodiment, outermost layer 255 comprises, in addition to the titanium dioxide pigment, the particles of caesium-doped tungsten oxide having an average particle size of 300 nm, and is thus an infrared-absorbent layer. Therefore, when the bank note is irradiated with infrared radiation and viewed in reflection or transmission with an infrared camera of a machine for authenticating banknotes, the entire opacified region, including security device 241 will appear dark, since layer 255 absorbs the incident infrared radiation. Security device 241 thus combines both overt and covert security features, thereby improving the level of protection against counterfeiting. Furthermore, the loss of infrared absorbency caused by abrasion or removal of layer 255 may be used in methods of detecting wear or damage to bank notes, as will be described in greater detail hereafter.

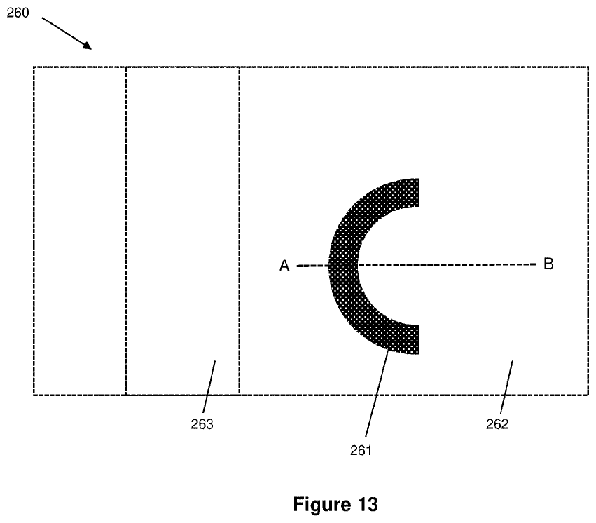

Another embodiment of the invention will now be described with reference to FIGS. 12 and 13, which depicts shadow mark 261 on opacified region 262 of bank note 260. Shadow mark 261 includes four titanium dioxide pigmented opacification layers 275a, 275b, 276 and 277, which are successively gravure printed at different printing stations.

Layer 275a is selectively printed in contrast area 278a on substrate 270, in the shape of a semicircle (or “C”-shape). Adjacent layer 275b is then selectively printed in contrast area 278b, also in the shape of a semicircle. Layers 277a and 275b are printed in register such that together they form an “O”-shaped ring of substantially constant pigment density on substrate 270. Layers 276 and 277 are then printed onto substrate 270, thus covering layers 278a and 278b and surrounding areas of substrate 270 over opacified region 262.

The difference in titanium dioxide pigment densities in contrast areas 278a/b, having three opacification layers on the substrate surface, and contrast areas 279, having two opacification layers on the substrate surface, provides visually contrasting opacities, which produce a positive “O”-shaped shadow image when security device 261 is observed by a viewer in natural light, as similarly depicted in FIG. 5.

However, in this embodiment, only layer 275a comprises, in addition to the titanium dioxide pigment, the particles of caesium-doped tungsten oxide having an average particle size of 300 nm. Therefore, when the bank note is irradiated with infrared radiation and viewed in reflection or transmission with an infrared camera of a machine for authenticating banknotes, the security device will be detected as a dark semi-circular region against a light background, as depicted in FIG. 13. Security device 261 thus combines an overt “O”-shaped shadow image feature and a covert “C”-shaped infrared security feature, thereby improving the level of protection against counterfeiting.

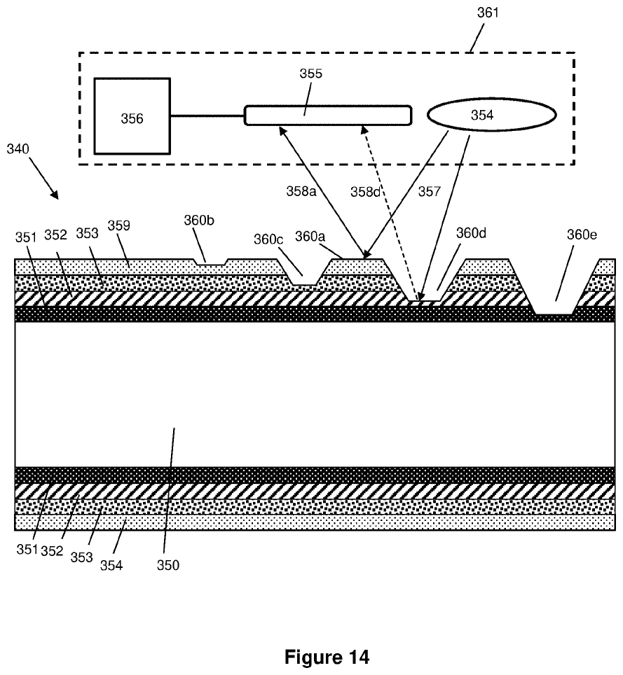

Another embodiment of the invention will now be described with reference to FIG. 14, which depicts bank note 340 positioned beneath scanner 361 of a machine for assessing bank note wear, damage or manufacturing quality. Scanner 361 includes radiation source 354 and infrared detector or camera 355, coupled to data processor 356.

Bank note 340 includes biaxially oriented polypropylene substrate 350 opacified with four overlaid opacification layers on each side, layers 351, 352, 353 and 359. The opacification layers comprise titanium dioxide particles with a particle size of 200 to 400 nm as pigment, the particles being dispersed in a cross-linked polymeric binder. Each opacification layer may be applied by gravure printing a coating composition onto a web of the substrate at a successive printing station along a roll-to-roll printing operation.

Opacification layers 351, 352 and 353 are infrared-absorbent layers comprising particles of caesium-doped tungsten oxide having an average particle size of 300 nm, while layer 359 is free of such particles. Layers 351, 352 and 353 comprise different loadings of the caesium-doped tungsten oxide particles, layer 351 having the highest loading and layer 353 having the lowest. Thus, the infrared absorbency of the individual opacification layers successively increases from outermost layer 359 to innermost layer 351.

In use, bank note 340 is conveyed beneath scanner 361 of a machine for assessing wear, damage or manufactured quality of bank notes. Scanner 361, operating in reflection mode, irradiates bank note 340 with radiation 357 from source 354, radiation 357 including at least a component of near-infrared spectrum radiation. A portion of radiation 357 incident on the opacified region of bank note 340 is scattered by the titanium dioxide pigment particles and thus partially reflected, the reflected radiation being detected by infrared detector 355. When an area of bank note 340 without substantial wear or damage, such as area 360a, is irradiated, reflected radiation 358 has an intensity, or spectral power distribution, consistent with the lack of infrared absorbing caesium-doped tungsten oxide particles at the surface of the bank note. A similar outcome results when area 360b, having only minor abrasion to outermost layer 359, is scanned.

However, when areas with a greater degree of wear or damage, sufficient to expose one of underlying opacification layers 353, 352 and 351 at the surface, are scanned, near-infrared wavelengths of radiation 357 incident on the area of wear are absorbed by the caesium-doped tungsten oxide particles. Thus, for example, reflected radiation 358d, from area 360d with layer 352 exposed at the surface, can be identified as a high wear area based on the loss of intensity of the near-infrared radiation component relative to radiation components such as visible white light. Moreover, since the degree of near-infrared absorption is dependent on the loading of the caesium-doped tungsten oxide particles in the exposed opacification layer, area of moderate wear 360c, area of high wear 360d and area of severe wear 360d may be differentiated from each other, and from relatively pristine areas 360a and 360b. The layer exposed at the surface may be determined by comparing the intensity of the reflected infrared radiation, for example the intensity relative to other components of the radiation, against one or more predetermined ranges characteristic of each the layers.

Data processor 356, coupled to detector 355, may thus be programmed to algorithmically accept or reject bank notes passing beneath scanner 361 based on comparison of the degree of wear against predetermined metrics. This advantageously provides an automated means for withdrawing worn or damaged bank notes from circulation. It is important that only bank notes of acceptable integrity remain in circulation, as the prevalence of worn and damaged bank notes provides counterfeiters with increased opportunity to pass off counterfeit bank notes as genuine. Alternatively, scanner 361 may be used to reject flawed bank notes from bank notes produced in a manufacturing process.

A “map” of bank note wear may also be produced by scanning used bank notes withdrawn from circulation, or sampled at various use intervals during circulation, since regions of higher infrared absorbency on the surface of the bank notes correlates to regions of high wear. This can provide information on patterns of use that cause wear of bank notes, such as folding, stapling, aggregating with paper clips and the like. The information may be useful for developing bank notes with enhanced durability for a particular market.

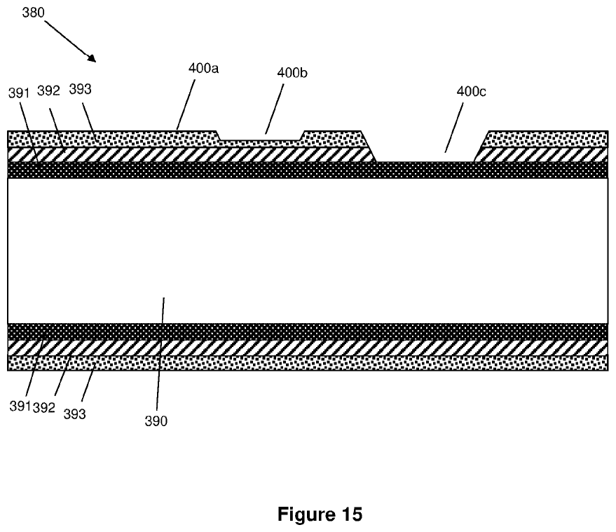

Another embodiment of the invention will now be described with reference to FIG. 15, which depicts bank note 380. Bank note 380 includes biaxially oriented polypropylene substrate 390 opacified on each side with inner opacification layer 392 and outer opacification layer 393. Infrared-absorbent layer 391 is present as a coating on both surfaces of substrate 390, thus lying intermediate the substrate and inner opacification layers 392.

Opacification layers 392 and 393 comprise titanium dioxide particles with a particle size of 200 to 400 nm as pigment, the particles being dispersed in a cross-linked polymeric binder. Infrared-absorbent layer 391 is a substantially transparent coating comprising particles of caesium-doped tungsten oxide having an average particle size of 300 nm. As described herein, layer 391 is thus free of particles other than the caesium-doped tungsten oxide particles. Layer 391 may optionally extend across the entire substrate, thereby also covering and imparting infrared absorbency to a window, as described herein. However it is not excluded that layer 391 is instead an opacification layer comprising titanium dioxide pigment particles. Each of layers 391, 392 and 393 may be applied by gravure printing appropriate coating compositions onto a web of the substrate at a successive printing station along a roll-to-roll printing operation.

Bank note 380 may be scanned in a machine for assessing wear or damage of bank notes, as described herein with reference to FIG. 14. In this embodiment, area of severe wear 400c, from which opacification layers 392 and 393 have been completely abraded or otherwise removed, will be detected by the scanner due to the absorbance of near-infrared radiation incident on exposed layer 391. By contrast, pristine area 400a and area of moderate wear 400b will not substantially absorb near-infrared radiation. This provides for a simple means for machine-sorting worn bank notes, from which parts of the opacification layers have been completely abraded, from bank notes which remain adequately opacified.

Another variation contemplated is to provide additional infra-red absorbent layers 391 between each of the opacification layers (such as also between layers 392 and 393 in FIG. 15). If each of the infra-red absorbent layers 391 comprises a different loading of the particles of caesium-doped tungsten oxide, the degree of wear (i.e. the number of opacification layers abraded away) may be assessed based on the degree of absorption of near-infrared wavelengths incident on the bank note.

Alternatively, in the embodiment illustrated in FIG. 15, the substrate 390 may be a substantially opaque substrate, for example a polymeric substrate including an opacifying additive added into the polymer during extrusion. The opaque substrate 390 may be coated with one or more layers 392 and 393 which are not opacification layers as in the case of transparent substrate. Instead, they are tactile layers which provide a matt or a paper feel to the opaque substrate 390, substantially similar to that of a paper based banknote. In other words, the bank note 380 is a polymer based note but provides its end users a paper like feel.

Again, an infrared-absorbent layer 391 may be provided which is a substantially transparent coating comprising particles of caesium-doped tungsten oxide having an average particle size of 300 nm. Preferably, layer 391 is free of particles other than the caesium-doped tungsten oxide particles. The infrared-absorbent layer 391 may be provided on selected areas of the opaque substrate 390, or alternatively extend across the entire substrate 390. Each of the layers 391, 392 and 393 may be applied by suitable printing techniques (e.g. gravure printing) such that appropriate coating compositions are deposited onto a web of the substrate 390 at successive printing stations along a roll-to-roll printing operation.

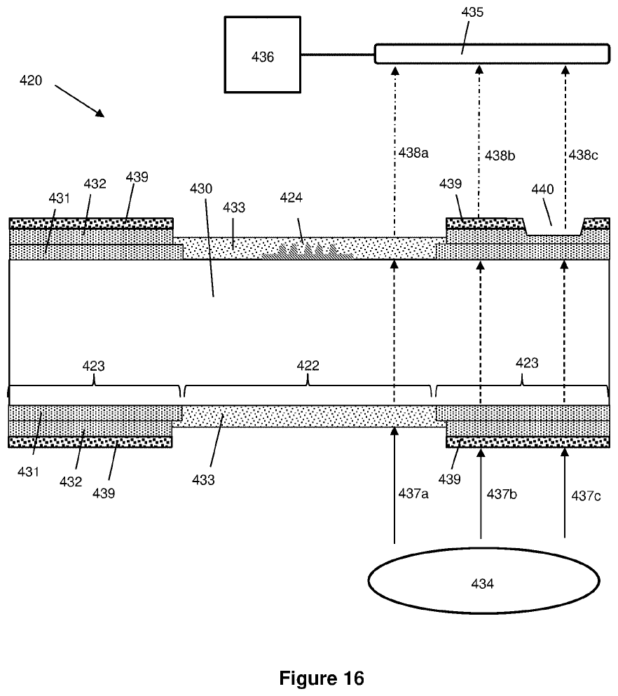

Another embodiment of the invention will now be described with reference to FIG. 16, which depicts bank note 420 positioned between infrared radiation source 434 and infrared detector 435 of a scanner in a machine for processing and inspecting bank notes. Bank note 420 includes transparent substrate 430 and titanium dioxide pigmented opacification layers 431 and 432 over opacified regions 423 of the bank note. Micro-structured, optically active security device 424 is formed on transparent window 422.

Infrared-absorbent coating 433 is present as a substantially transparent coating over both faces of window 422, and fills the optically active formations of security device 424. Coating 433 comprises both particles of caesium-doped tungsten oxide having an average particle size of 300 nm and nanoparticles of zirconium dioxide, dispersed in a polymeric matrix. As such, coating 433 renders window 422 absorbent in the near-infrared region, while remaining adequately transparent. Coating 423 also physically protects security device 424 and maintains the optical effect of its three-dimensionally structured formations due to a refractive index contrast, as described herein.

Infrared-absorbent coating 439 is present as a coating on top of opacification layers 431 and 432. Coating 439 also comprises particles of caesium-doped tungsten oxide having an average particle size of 300 nm, for their infrared absorbent properties. Optionally, coating 439 is the same high refractive index coating as coating 433 (thus also including the zirconium dioxide nanoparticles); in this manner, coatings 433 and 439 may be applied in a single printing step as a continuous coating over bank note 420. Alternatively, coating 439 may be separately printed, and either comprise pigment particles (thus forming an outermost opacification layer), or lack particles other than the particles of caesium-doped tungsten oxide (thus forming a low refractive index, transparent layer).

As a result of infrared-absorbent coating 433, window 422 is detectable by irradiating the window with radiation 437a from infrared radiation source 434, and detecting transmitted radiation 438a via infrared detector 435. The attenuated intensity of near-infrared wavelengths in radiation 438a is assessed by data processor 436 as indicative of the presence of bank note 300, as described herein for bank note 100. Bank note 420 may thus be readily processed in a bank note processing machine, such as an ATM or machine for segregating worn bank notes, which must accurately ascertain the presence and/or relative position of bank notes in the machine. The attenuation of the near-infrared radiation component in transmitted radiation 438a may be also used as an indicator of manufacturing quality or of damage or wear to window 422.

Furthermore, the infrared-absorbency of coating 439 may also be used in methods for assessing wear or damage in opacified areas of bank notes, or of identifying faulty bank notes in manufacture. Radiation 437b and radiation 437c incident on opacification area is 423 is transmitted through bank note 420 as transmitted radiation 438b and 438c. Radiation 437c, however, is transmitted through area of wear 440, from which composition 439 has abraded away on one side, leaving underlying opacification layer 432 exposed. As a result of the reduced path distance through infrared-absorbent coating 439, the intensity of near-infrared wavelengths in transmitted radiation 438c is higher than in transmitted radiation 438b, allowing the area of damage to be identified.

### EXAMPLES

The present invention is described with reference to the following examples. It is to be understood that the examples are illustrative of and not limiting to the invention described herein.

### Example 1

Transparent, biaxially-oriented polypropylene film, suitable for use as a bank note substrate, was gravure-printed with various transparent or opacified coating compositions. The coating compositions included a carrier fluid, a transparent binder, and particulate TiO₂ (for the opacified coatings). When required to produce an infrared-absorbent layer, the coating compositions further contained particles of Cs_{0.33}WO₃ with an average crystallite size of 300 nm, at a loading in the coating composition of c.a. 24 weight %, sufficient to deposit c.a. 0.7 g/m² in each printed layer. After printing, the compositions were cured and dried to produce adhered layers prior to overprinting with any further layers.

Samples were produced as shown in Table 1, including a sample with a transparent region (window) having a single transparent layer containing Cs_{0.33}WO₃, a sample with an opacified region including two opacified layers on one side and three opacified layers on the other side (none containing Cs_{0.33}WO₃), a sample having an opacified region including a single transparent layer containing Cs_{0.33}WO₃ (directly adjacent the substrate) and additionally two opacified layers on one side and three opacified layers on the other side, and a sample having an opacified region including an opacified layer containing both TiO₂ pigment and Cs_{0.33}WO₃ (directly adjacent the substrate) and additionally two opacified layers on one side and three opacified layers on the other side. The coated transparent and opacified regions had a visual appearance suitable for windows and opacified regions on polymer-based bank notes.

The infrared absorbency of the samples was then then measured in transmission using an Ocean Optics FLAME-S-VIS-NIR spectrometer, connected to QP400-1-VIS-NIR optical fibre cables, and 74-ACR collimating lenses. The light source was a Mikropack DH-200-BAL light source, also from Ocean Optics.

The results are shown in Table 1, together with comparative results for the uncoated polypropylene film and the window of a current AU$5 polymer-based bank note. The edge-to-edge window of the AU$5 polymer-based bank note presents difficulties for certain bank note processing machines with infrared sensors designed to detect paper bank notes.

TABLE 1

| | | Transmission |
|---|---|---|
| | | at 880 |
| Banknote region | Sample | nm (%) |
| Transparent window | Uncoated (comparative) | 100 |
| Transparent window | Coated with transparent | 60.7 |
| | layer comprising | |
| | Cs_{0.33}WO₃ particles | |
| Transparent window | Window of AU$ 5 banknote | 78.2 |
| | (comparative) | |
| Opacified region | Coated with 5 opacification | 37.6 |
| | layers, each | |
| | comprising particulate TiO₂ | |
| Opacified region | Coated with a transparent | 13.6 |
| | layer comprising | |
| | Cs_{0.33}WO₃ particles, | |
| | then coated with 5 | |
| | opacification layers | |
| | comprising particulate TiO₂ | |
| Opacified region | Coated with one opacified | 26.3 |
| | layer comprising | |
| | Cs_{0.33}WO₃ particles and | |
| | particulate TiO₂ then | |
| | coated with 5 opacification | |
| | layers comprising | |
| | particulate TiO₂ | |
| Paper bank note | Paper bank note (comparative) | <5% |

It is evident that the transparent coating comprising particles of Cs_{0.33}WO₃ exhibits excellent near infrared-absorbency, within a range considered to be acceptable for detection by existing bank note processing machines designed primarily for paper bank notes. At the same time, the coating is suitably transparent for a bank note window, i.e. substantially non-absorptive of visible light.

It is further evident that an opacified region comprising particles of Cs_{0.33}WO₃ has a significantly differentiated infrared-absorbency from that of an opacified region lacking such particles. The difference is sufficient to produce a covert IR-detectable feature. Opacified regions on polymer-based bank notes are generally designed to produce a substantially opaque appearance similar to that of paper bank notes, and it is surprising that a covert IR-detectable feature can be produced within an opacified region such that adequate contrast is provided relative to the background.

### Example 2

A test bank note with an opacified region was prepared by sequentially gravure printing overlying opacification layers of a TiO₂-pigmented coating composition onto a transparent, biaxially oriented polypropylene film. An innermost layer on one side was printed in the form of a polar bear and flying bird with a coating composition comprising, in addition to the TiO₂ pigment, particles of Cs_{0.33}WO₃ with an average crystallite size of 300 nm, at a loading in the coating composition of c.a. 24 weight %, sufficient to deposit c.a. 0.7 g/m² in the layer. The other five layers (two layers on one side, three layers on the other) were printed as uniform coatings over the entire opacified region. After printing each layer, the printed composition was cured and dried to produce adhesion prior to the next printing step.

The resultant distribution of particulate pigment density on the transparent substrate produced a positive shadow image of the polar bear and bird with a bluish tinge, clearly visible in natural light.

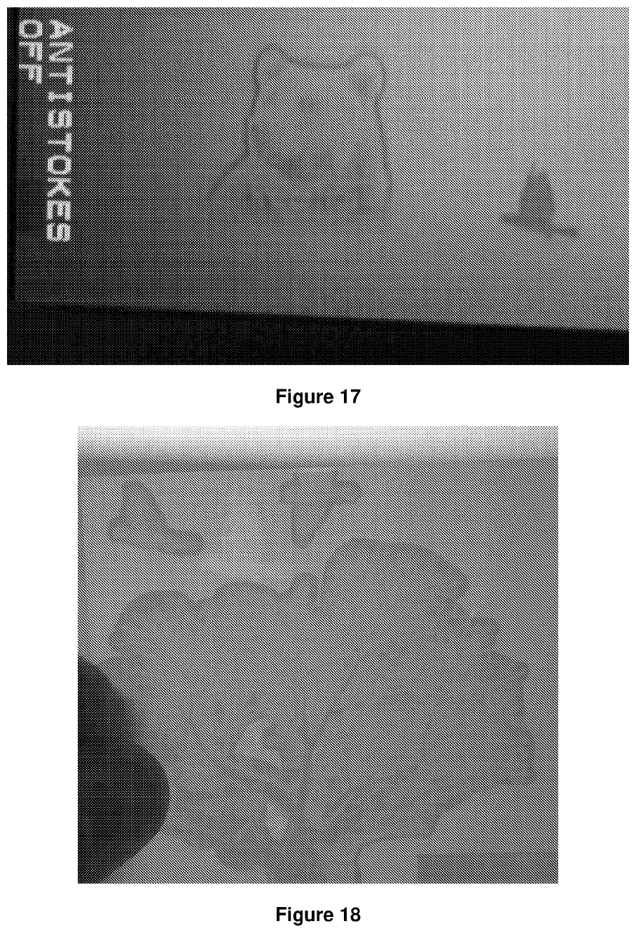

The bank note was then inspected with a DORS 1170 counterfeit detector, a note inspection machine used to detect covert IR features by irradiating the bank note with infrared radiation and imaging the radiation reflected by the bank note with an infrared camera. A photograph of the resultant image on the imaging screen is depicted in FIG. 17. The covert image produced a bright and well-defined image of the polar bear and bird, with excellent contrast against the surrounding opacified region.

In another example, a similar test bank note was printed, except that the innermost layer containing the particles of Cs_{0.33}WO₃ was a transparent composition lacking TiO₂ pigment. In this case, a visible shadow image was produced due to the blue tinge of the Cs_{0.33}WO₃ contrasting against the surrounding opacified regions. The covert image detected on the DORS 1170 counterfeit detector was similar to that depicted in FIG. 17.

Another test bank note was prepared by initially printing a transparent coating composition, comprising the particles of Cs_{0.33}WO₃ at loadings as described in Example 1, onto a transparent film in the shape of a tree (in part) and two birds. Layers of TiO₂-opacified coating composition were then sequentially gravure printed over the film (two layers on one side, three layers on the other). One of the opacified layers was printed to be selectively omitted from areas of the substrate corresponding to intricate features of the tree, the two birds and a third bird. The other opacified layers were printed as uniform coatings over the entire opacified region. After printing each layer, the printed composition was cured and dried to produce adhesion prior to the next printing step.

The resultant distribution of particulate pigment density on the transparent substrate produced a finely-resolved negative shadow image of a tree and three birds, clearly visible to a viewer in natural light as depicted in FIG. 18.

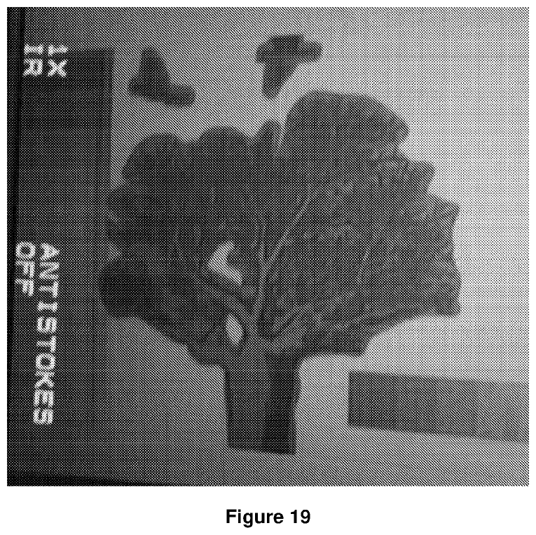

The bank note was then inspected with the DORS 1170 counterfeit detector. A photograph of the resultant image on the imaging screen is depicted in FIG. 19. The covert image produced a bright and well-defined image of the two birds and tree, corresponding to the areas printed with the Cs_{0.33}WO₃-containing layer and having excellent contrast against the surrounding opacified region.

Those skilled in the art will appreciate that the invention described herein is susceptible to variations and modifications other than those specifically described. It is understood that the invention includes all such variations and modifications which fall within the spirit and scope of the present invention.

Future patent applications may be filed in Australia or overseas on the basis of or claiming priority from the present application. It is to be understood that the following provisional claims are provided by way of example only, and are not intended to limit the scope of what may be claimed in any such future application. Features may be added to or omitted from the provisional claims at a later date so as to further define or re-define the invention or invention.

1. A security document having a transparent window, the security document comprising:
a polymeric substrate; and
an infrared-absorbent composition coated on or incorporated within the substrate at the window, the infrared-absorbent composition comprising particles of doped or Magnéli phase tungsten oxide.

2. The security document of claim 1, wherein the particles of doped or Magnéli phase tungsten oxide are present at a loading of between about 0.12 g/m² and about 1.2 g/m², preferably between about 0.5 g/m² and about 0.75 g/m².

3. The security document of claim 1, wherein the particles of doped or Magnéli phase tungsten oxide are present at a loading sufficient to absorb at least 20% of an intensity of at least one wavelength of infrared radiation, preferably near infrared radiation, when light comprising the infrared radiation is transmitted through the window.

4. The security document of claim 1, wherein the window is an edge window, preferably an edge-to-edge window.

5. The security document of claim 1, wherein the infrared-absorbent composition is coated on the window in a transparent coating.

6. The security document of claim 5, wherein the coating entirely covers the window on at least one side.

7. The security document of claim 5, wherein the coating further comprises metal oxide nanoparticles at a loading sufficiently high to provide a contrast between a refractive index of the coating and a refractive index of the substrate or any surface relief layer thereon.

8. The security document of claim 7, wherein the coating fills three-dimensionally structured formations of a surface relief layer on the substrate, wherein the contrast maintains a visible optical effect of the formations.

9. The security document of claim 5, wherein the coating comprises a transparent varnish.

10. The security document of claim 1, wherein the substrate is substantially opaque, said opaque substrate being formed by inclusion of an opacifying additive such as titanium dioxide into a clear polymer during extrusion.

11. The security document of claim 1, wherein the substrate is transparent.

12. The security document of claim 1, wherein the doped or Magnéli phase tungsten oxide is caesium-doped tungsten oxide.

13. The security document of claim 12, wherein the caesium-doped tungsten oxide has a formula of CsₓWO₃, wherein x is between 0.2 and 0.4, and is preferably about 0.33.

14. The security document of claim 1, wherein the particles of doped or Magnéli phase tungsten oxide have an average particle size of below 1000 nm, and preferably below about 350 nm.

15. The security document of claim 1, wherein the security document is a bank note.

16. A method of detecting or inspecting a security document having a transparent window, the security document comprising: a polymeric substrate; and an infrared-absorbent composition coated on or incorporated within the substrate at the window, the infrared-absorbent composition comprising particles of doped or Magnéli phase tungsten oxide, the method comprising:
irradiating the window with light comprising at least infrared radiation; and
detecting the infrared radiation transmitted through or reflected by the window and/or a security device thereon.

17. The method of claim 16, wherein detecting the infrared radiation comprises measuring an intensity of the infrared radiation transmitted through the window.

18. The method of claim 16, wherein the substrate is substantially opaque, said opaque substrate being formed by inclusion of an opacifying additive such as titanium dioxide into a clear polymer during extrusion.

19. The method of claim 16, wherein the substrate is transparent.

20. The method of claim 16, wherein the doped or Magnéli phase tungsten oxide is caesium-doped tungsten oxide.

21. The method of claim 20, wherein the caesium-doped tungsten oxide has a formula of CsₓWO₃, wherein x is between 0.2 and 0.4, and is preferably about 0.33.

22. The method of claim 16, wherein the particles of doped or Magnéli phase tungsten oxide have an average particle size of below 1000 nm, and preferably below about 350 nm.

23. The method of claim 16, wherein the security document is a bank note.
